(19) United States
(12) Patent Application Publication
(10) Pub. No.: US 2006/0119588 A1
(43) Pub. Date: Jun. 8, 2006

(54) Apparatus and method of processing information input using a touchpad

(76) Inventors: Sung-min Yoon, Seoul (KR); Baum-sauk Kim, Seoul (KR); Yong-hoon Lee, Suwon-si (KR)

Correspondence Address: STANZIONE & KIM, LLP, 919 18TH STREET, N.W., SUITE 440, WASHINGTON, DC, 20006, US

(21) Appl. No.: 11/288,332

(22) Filed: Nov. 29, 2005

(30) Foreign Application Priority Data
Dec. 3, 2004 (KR) 2004-101245

(51) Int. Cl. G09G 5/00

(52) U.S. Cl. 345/173

(57) ABSTRACT

Apparatus and method of processing touchpad input information are provided. The method includes mapping an input region of a touchpad to a display region as absolute coordinates, converting contact location coordinates into absolute coordinates, when a pointing tool touches the input region, and moving a mouse pointer displayed on the display region according to the converted contact location coordinates. The input region of a touchpad is mapped to a display region as absolute coordinates such that information can be directly input using the touchpad.

### CROSS-REFERENCE TO RELATED APPLICATIONS

This application claims priority the benefit of priority under U.S.C. §119 from Korean Patent Application No. 2004-101245 filed on Dec. 3, 2004, in the Korean Intellectual Property Office, the disclosure of which is incorporated herein in its entirety by reference.

### BACKGROUND OF THE INVENTION

1. Field of the Invention

The present general inventive concept relates to an apparatus and method of processing information input using a touchpad, and more particularly, to an apparatus and method of processing information input using a touchpad, which enables a user to directly input information using the touchpad by mapping the touchpad and a predetermined display region as absolute coordinates.

2. Description of the Related Art

User interface devices (hereinafter, referred to as input devices) allow a user to input desired information into a computer. A keyboard is an example of a widely used input device. A keyboard includes multiple keys each having a key signal output therefrom to be mapped to each number or character, thereby enabling the user to easily input desired information into the computer. In particular, the keyboard allows the user to efficiently input desired characters when editing a document using the computer, as a variety of techniques in the computer industry have been developed to enhance the user's experience and to make computers more versatile.

In addition to the keyboard, a pointing device such as a mouse, a touchpad or a touch screen is often used as the input device. A pointing device provides a user with convenience when moving a cursor (for example, a mouse pointer) displayed on a display unit (for example, a monitor of a computer) or selecting a specific icon.

In recent years, engineers have developed technology in which information input using a pointing device, such as Microsoft input method editor (IME) is recognized as a character. For example, in link with a document editing application module, the IME recognizes the information input by the pointing device as a character and provides the recognized character to the document editing application module.

This technology is used conveniently and flexibly when a keyboard is used to create a document in language characters such as Chinese, Japanese, or Arabic characters, requiring to then be converted into an alphanumerical mode document. This technology may particularly be useful when a user inputs strokes into phonetic and ideographic character even though the pronunciation of the input character is difficult and the user may not know the accurate pronunciation of the input character.

However, the conventional technology presents the following drawbacks.

First, to input a character a user moves a mouse pointer while pressing a mouse button located on the mouse. In this case, the user inputs a character using his or her wrist joint, and the number of strokes involved in inputting the character makes the inputting process an inefficient one. In addition, because of imprecise strokes while using the mouse, the wrong character may be rendered. In particular, when using the mouse the larger the number of strokes needed to input a more complex character, thus, the lower the character recognition efficiency becomes. For these reasons, conventional technology has not adequately addressed the efficient character recognition.

Meanwhile, a touchpad is a pointing device serving as a mouse, and is widely used in light-weight, small-sized notebook computers. A character input using the touchpad as a pointing tool, such as a finger, a joystick or a pen, is more efficient recognized than using a mouse.

However, since the touchpad performs the same function as that of the mouse, in order to distinguish a mouse pointer movement for character inputting from general mouse pointer movement, the user should press a mouse button provided in the touchpad when inputting a character.

A conventional operation of inputting a character using a touchpad will now be described with reference to FIG. 1, in which an IME is linked with a document editor 110.

A user inputs a character using an IME application through an IME input window 120. The user edits a document using the document editor 110. When the IME input window 120 is displayed, the user drags a pointing tool and moves a mouse pointer 130 displayed on a display unit to the IME input window 120 in a state in which the pointing tool touches the touchpad (1).

An operation of inputting a Korean language character, known as a Hangul, ‘ [symbol] (Ka)’ consisting of three components, that is, ‘ [symbol] ’, ‘┐’, and ‘-’ is provided as an example.

After moving the mouse pointer 130 to the IME input window 120, the user drags the pointing tool on the touchpad while the mouse button is pressed, and inputs the first component ‘ [symbol] ’ (2).

In order to input the second component ‘┐’, the mouse pointer 130 should be moved to location ‘a’. To this end, the user releases pressure applied to the mouse button, drags the pointing tool on the touchpad, and then moves the mouse pointer 130 to the location ‘a’ (3).

When the mouse pointer 130 is at the location ‘a’ on the display unit, the user drags the pointing tool on the touchpad while the mouse button is pressed, and inputs the second component ‘┐’ (4).

To input the third component ‘-’, the user releases the pressure applied to the mouse button, drags the pointing tool on the touchpad, and then moves the mouse pointer 130 to location ‘b’ (5).

When the mouse pointer 130 is at the location ‘b’, the user drags the pointing tool on the touchpad while the mouse button is pressed, and inputs the third component ‘-’ (6).

In the prior art, when a user inputs a character using a touchpad, the user has to simultaneously operate a mouse button while repeatedly dragging a pointing tool to input a character and moving a mouse pointer. This operation mode becomes increasingly burdensome in time to the user. Accordingly, as the number of strokes of a character increases, user's inconvenience associated with character input using the touchpad unavoidably increases. This is because the touchpad and the entire display region of the display unit correspond to relative coordinates.

Meanwhile, in the case of using the touch screen, the user can directly input a character on the touch screen as if the user actually wrote using a pen. However, the touch screen is a high-priced pointing device and thus, is not suitable for a low-priced personal computer (PC) that is widely used by general users.

Japanese Patent Laid-open Publication No. 2003-196007 (Character Input device) discloses a technology which allows a virtual keyboard to be displayed on a display unit, and a user moves a mouse pointer on the virtual keyboard using a touchpad and inputs a character mapped to the virtual keyboard. In a case of a language having a large number of basic characters, however, it is difficult to map all of the basic characters to keys provided on a virtual keyboard. In addition, since the user should search for desired characters on the virtual keyboard one by one, a user who is unskilled at using the virtual keyboard may experience an inconvenience.

Accordingly, similar to the case of using the touch screen, there is a need for better techniques enabling user's direct information to be input using a touchpad.

### SUMMARY OF THE INVENTION

The present general inventive concept provides an apparatus and method of processing information input using a touchpad, which enables a user to directly input information using the touchpad by mapping the touchpad to a predetermined display region as absolute coordinates.

Additional aspects and advantages of the present general inventive concept will be set forth in part in the description which follows and, in part, will be obvious from the description, or may be learned by practice of the general inventive concept.

The foregoing and other aspects of the present general inventive concept may be achieved by providing a method of processing touchpad input information, the method including mapping an input region of a touchpad to a predetermined display region as absolute coordinates, converting contact location coordinates into the absolute coordinates, when a pointing unit touches the input region, and moving a mouse pointer displayed on the display region according to the converted contact location coordinates.

The foregoing and other aspects of the present general inventive concept may also be achieved by providing a method of recognizing characters from information input using an input device capable of sensing a touch and generating touch location coordinates, the method including defining a correspondence between a plurality of location coordinates of the input device and a plurality of absolute coordinates of the display, converting the touch location coordinates generated by the input device into the absolute display coordinates, displaying the absolute coordinates, and recognizing a character based on a largest correlation between a sequence of coordinates and a reference character from a plurality of reference characters.

The foregoing and other aspects of the present general inventive concept may also be achieved by providing a method of processing locations pointed to within a predetermined area, the method including mapping the input region of the predetermined area to a display region of a display as absolute coordinates, converting location coordinates in the predetermined area into absolute coordinates when the locations are pointed to, and moving a pointer along the display region corresponding to the converted location coordinates pointed to.

The foregoing and other aspects of the present general inventive concept may also be achieved by providing an apparatus to process touchpad input information, the apparatus including a coordinate setting unit to map location coordinates of an input region of a touchpad to a display region as absolute coordinates, a coordinate converting unit to convert location coordinates where a pointing tool touches the input region into the corresponding absolute coordinates, and a mouse pointer controlling unit to move a mouse pointer displayed on the display region according to the converted contact location coordinates.

The foregoing and other aspects of the present general inventive concept may also be achieved by providing an apparatus to recognize characters from information input using an input device capable of sensing a touch and outputting touch location coordinates, the apparatus comprising a display, a converting unit to convert touch location coordinates sensed by the input device into absolute display coordinates, a group processing unit to group a sequence of absolute coordinates and control displaying the group of coordinates on the display, and a recognizing unit to recognize a character based on largest correlation between a group of coordinates and a reference character from a plurality of reference characters.

The foregoing and other aspects of the present general inventive concept may also be achieved by providing an apparatus to process locations pointed to within a predetermined area, the apparatus including a mapping unit to map the input region of the predetermined area to a display region of a display as absolute coordinates, a conversion unit to convert location coordinates in the predetermined area into absolute coordinates when the locations are pointed to, and a display to display the movements of a pointer along the display region corresponding to the converted location coordinates pointed to.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a conventional method of inputting a character using a touchpad;

FIG. 2 is a block diagram of an apparatus to input information using a touchpad according to an embodiment of the present general inventive concept;

FIG. 3 is a block diagram of a controlling unit shown in FIG. 2;

FIG. 4 illustrates the movement of a mouse pointer according to an embodiment of the present general inventive concept;

FIG. 5 is a flowchart illustrating a method of processing touchpad input information according to an embodiment of the present general inventive concept;

FIG. 6 is a flowchart illustrating a method of recognizing a character according to an embodiment of the present general inventive concept; and

FIG. 7 is a flowchart illustrating a method of recognizing a character according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like f reference numerals refer to the like elements throughout. The embodiments are described below in order to explain the present general inventive concept while referring to the figures.

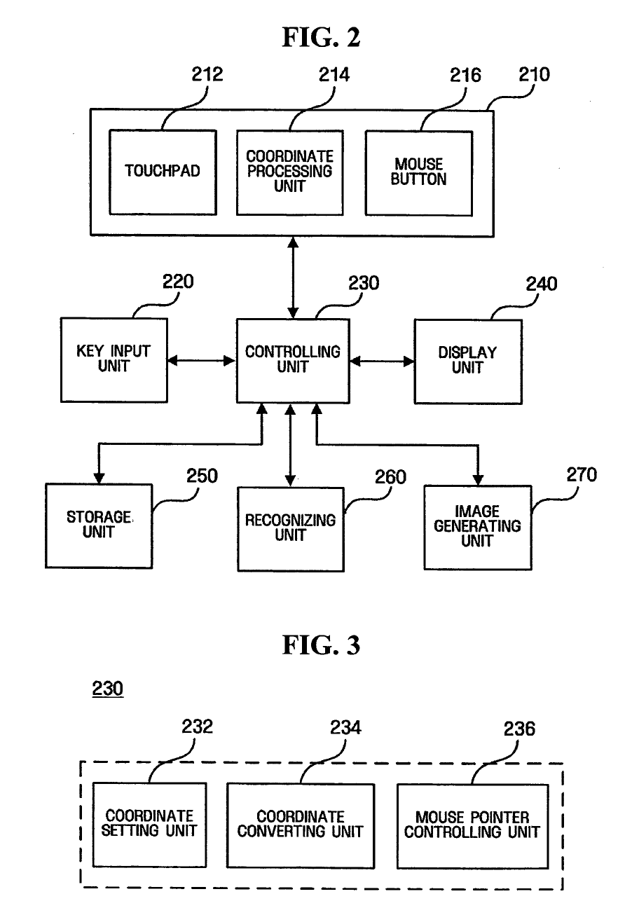

FIG. 2 is a block diagram of an apparatus to input information using a touchpad according to an embodiment of the present general inventive concept.

The apparatus of FIG. 2 includes a touchpad unit 210, a key input unit 220, a controlling unit 230, and a display unit 240. The apparatus further includes a storage unit 250, a recognizing unit 260, and an image generating unit 270.

The touchpad unit 210 includes a touchpad 212 and a coordinate processing unit 214. The touchpad 212 senses a touch point when a pointing tool touches an input region of the touch pad 212 and outputs an analog signal generated by the touch to the coordinate processing unit 214. In this case, the coordinate processing unit 214 generates a digital signal having contact location coordinates of the pointing tool that touches the touchpad 212 and outputs the digital signal to the controlling unit 230.

For example, when the touchpad 212 is of a pressure-sensitive type, the touchpad 212 is constructed of two resistant sheets overlapping each other, the two resistant sheets having a fine gap therebetween. When the pointing tool touches the touchpad 212, the resistant sheets touch each other at the point and electricity flows between the resistant sheets. In response to the touch of the pointing tool, the touchpad 212 generates an analog signal and outputs the signal to the coordinate processing unit 214. The coordinate processing unit 214 extracts the information about a corresponding contact location and outputs the information as a digital signal. Thus, if the pointing tool is dragged while being in touch with the touchpad 212 (more specifically, a touch region of the touchpad 212), the coordinate processing unit 214 can sense a movement path of the touch point, generate contact location coordinates corresponding to the movement path, and output the generated contact location coordinates to the controlling unit 230.

However, the touchpad used in the present general inventive concept is not limited to the touchpad of a pressure-sensitive type, and can include other types of devices capable of sensing a touch and outputting contact location coordinates.

The touchpad unit 210 may include at least one mouse button 216 having the same shape and function as a conventional mouse button.

The key input unit 220 may include at least one key and outputs a key signal corresponding to a pressed key to the controlling unit 230. Each key signal is mapped to a number, a character, or input information having a specific function. Thus, the user can operate the key input unit 220 and set a touchpad input mode to a relative coordinate mode or an absolute coordinate mode.

The controlling unit 230 may move a mouse pointer displayed on the display unit 240 in response to the signal output from the touchpad unit 210.

More specifically, the controlling unit 230 may include a coordinate setting unit 232, a coordinate converting unit 234, and a mouse pointer controlling unit 236, as illustrated in FIG. 3.

If the touchpad input mode is a relative coordinate mode, the coordinate setting unit 232 sets the touchpad 212 and the entire display region of the display unit 240 to correspond to each other as relative coordinates. In this case, if the pointing tool is dragged while being in contact with the touchpad 212, the coordinate converting unit 234 converts the contact location coordinates into relative coordinates, the contact location coordinates corresponding to a change between contact locations of the pointing tool before and after the dragging operation. The mouse pointer controlling unit 236 moves the mouse pointer displayed on the display unit 140 according to the converted contact location coordinates.

In this case, the movement of the mouse pointer using the touchpad 212 is carried out according to the same method as in the conventional method. That is, in the relative coordinate mode, the location of the mouse pointer displayed using the display unit 240 cannot be changed only in a state where the pointing tool contacts a specific point of the touchpad 212. Thus, in order to change the location of the mouse pointer, the pointing tool should be dragged in the relative coordinate mode while contacting the touchpad 212.

If the touchpad input mode is an absolute coordinate mode, the coordinate setting unit 232 sets the touchpad 212, or more specifically, sets an input region of the touchpad 212, and a specific display region of the display unit 240 to correspond to each other as absolute coordinates. As such, the touchpad 212 is 1:1 mapped to the specific display region.

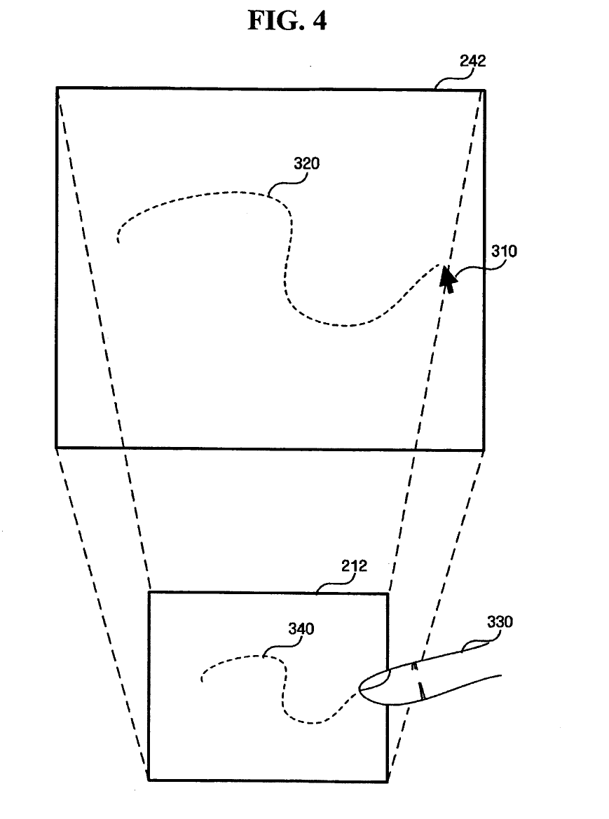

In this case, the coordinate converting unit 234 converts contact location coordinates input from the touchpad unit 210 into absolute coordinate values. The mouse pointer controlling unit 236 controls movement of the mouse pointer on the display region mapped to the touchpad 212 according to the converted contact location coordinates. An example thereof is illustrated in FIG. 4.

Referring to FIG. 4, if the absolute coordinate mode is set, a mouse pointer 310 is confined in the display region 242 mapped to the touchpad 212 as the absolute coordinates. Thus, the mouse pointer 310 on the display region 242 moves according to the absolute location coordinates and follows the same path as the path (drag path) 340 on which the pointing tool 330 is dragged across the touchpad 212. In this case, a movement path 320 of the mouse pointer 310 corresponds to a scaled value by an area proportion of the touchpad 212 to the display region 242 with respect to the drag path 340 of the pointing tool 330.

Unlike in the relative coordinate mode, in the case of the absolute coordinate mode, if only the pointing tool 330 contacts the touchpad 212, the mouse pointer 310 can be positioned on the coordinates of the display region 242 corresponding to the contact point.

Likewise, the display region 242 mapped to the touchpad 212 as the absolute coordinates may correspond to the entire display region of the display unit 240 or to a partial display region of the display unit 240. As such, when the user executes a specific application on a computer, the mouse pointer 310 is confined to a display region, such as for example, an execution window pop-up displayed when a Microsoft Windows series computer operating system (OS) is used. The execution state of the application is displayed in the window. Similarly, the user can directly move the mouse pointer 310 in a corresponding display region using the touchpad 212.

The mouse pointer controlling unit 230 can display the movement path of the mouse pointer 310 on the display region where the touchpad 212 is mapped to as absolute coordinates. For example, when the user drags the pointing tool 330 across the touchpad 212, as illustrated in FIG. 4, the movement path 320 of the mouse pointer 310 can be visually displayed to the user.

When the selected operation mode is the absolute coordinate mode, the controlling unit 230 converts the contact location coordinates output from the touchpad unit 210 into absolute coordinates, and the storage unit 250 stores the converted contact location coordinates. In this case, when the contact location coordinates output from the touchpad unit 210 are converted by the controlling unit 230 into absolute coordinates before recognition by the recognizing unit 260 or before image generation by the image generating unit 270 is performed, the storage unit 250 stores the converted contact location coordinates as one group. Thus, when the contact location coordinates output from the touchpad unit 210 are converted by the controlling unit 230 into the absolute coordinates after recognition using the recognizing unit 260 or after image generation using the image generating unit 270 is performed, the storage unit 250 stores the converted contact location coordinates as a new group. The combination of contact location coordinates stored as one group in the storage unit 250 has the same coordinate values as coordinates that constitute a path of movement of the mouse pointer displayed on the display region where the touchpad 212 is mapped to as the absolute coordinates.

The recognizing unit 260 recognizes a character using the combination of contact location coordinates that form one group stored in the storage unit 250. To this end, the recognizing unit 260 can store a standard character which is used as a basis to recognize a variety of characters. The recognizing unit 260 searches for the standard character having the largest correlation with the contact location coordinates and recognizes the searched standard character as a character or symbol that a user wants to input. The recognizing unit 260 can perform recognition using a conventional character recognizing technology.

A recognition operation can be performed by the recognizing unit 260 when the pointing tool does not touch the touchpad 212 for more than a threshold time interval. Alternatively, the recognition operation may be performed when a recognition command is input using a key input unit 220, a touchpad unit 210 or other user interface unit (not shown).

The image generating unit 270 generates an image corresponding to a movement path of the mouse pointer displayed on the display region mapped to the touchpad 212 as the absolute coordinates. Similar to the character recognition operation, the image data generating operation may also be performed when the pointing tool does not touch the touchpad 212 for more than a threshold time interval, or when an image data generating command is input by the user.

The generated image data may be stored in the storage unit 250 and displayed on the display unit 240 according to a user's request.

A method of processing touchpad input information according to an embodiment of the present general inventive concept will now be described with reference to the accompanying drawings.

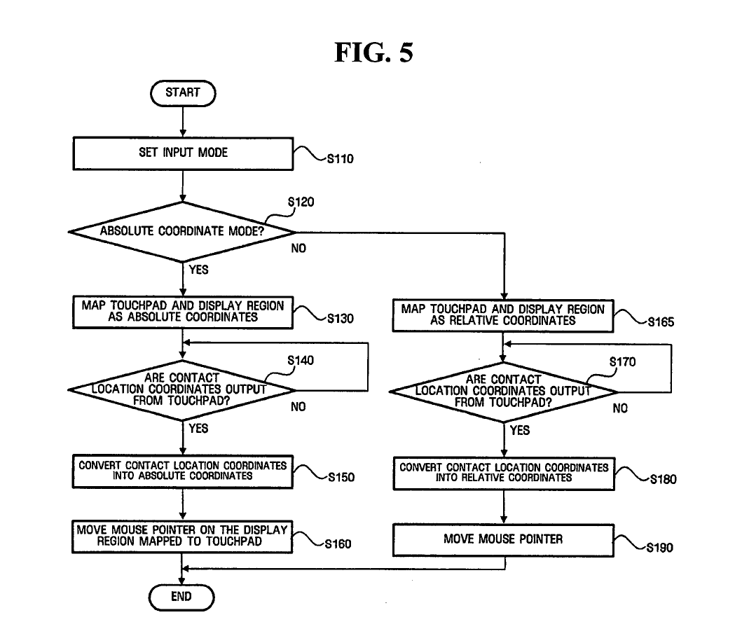

FIG. 5 is a flowchart illustrating a method of processing touchpad input information according to an embodiment of the present general inventive concept.

In operation S110, a touchpad input mode is initially set by a user. An input mode setting command may be input using the key input unit 220, the touchpad unit 210 or other user interface unit (not shown).

In operation S120, the coordinate setting unit 232 determines whether the input mode is an absolute coordinate mode. If it is determined that the input mode is set to the absolute coordinate mode, in operation S130, the coordinate setting unit 232 maps an input region of the touchpad 212 and a predetermined display region on the display unit 240 to the absolute coordinates. As such, the input region of the touchpad 212 is 1:1 mapped to the predetermined display region.

If the pointing tool contacts the touchpad 212 and location coordinates are output from the touchpad 212 in operation S140, the touchpad unit 210 outputs the contact location coordinates to the coordinate converting unit 234. The coordinate converting unit 234 then converts the contact location coordinates output from the touchpad unit 210 into the absolute coordinates in operation S150. In operation S160, the mouse pointer controlling unit 236 moves the mouse pointer 310 on the display region 242 according to the contact location coordinates converted by the coordinate converting unit 234 from the mapped region of the touchpad 212.

If the set input mode is not the absolute coordinate mode but rather a relative coordinate mode, in operation S165, the coordinate setting unit 232 maps the touchpad 212 to the entire display region of the display unit 240 as relative coordinates.

If the pointing tool contacts the touchpad 212 in operation S170 and location coordinates are output from the touchpad 212, the touchpad unit 210 outputs the contact location coordinates to the coordinate converting unit 234 and the coordinate converting unit 234 converts the contact location coordinates output from the touchpad unit 210 as the relative coordinates. In operation S190, the mouse pointer controlling unit 236 moves the mouse pointer 310 on the display unit 240 according to the contact location coordinates converted by the coordinate converting unit 234.

If the mouse pointer 310 is moved in the absolute coordinate mode in operation S160, the mouse pointer controlling unit 236 may display the movement path of the mouse pointer on the display region using the display unit 240.

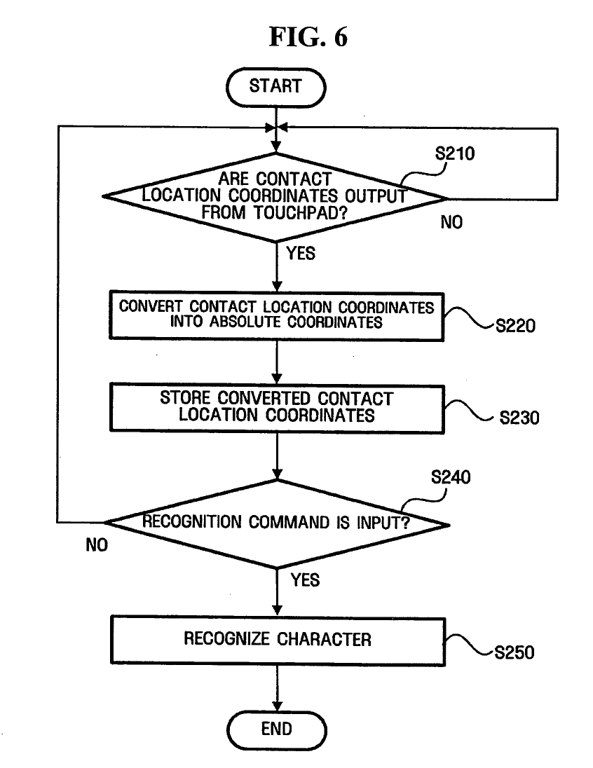

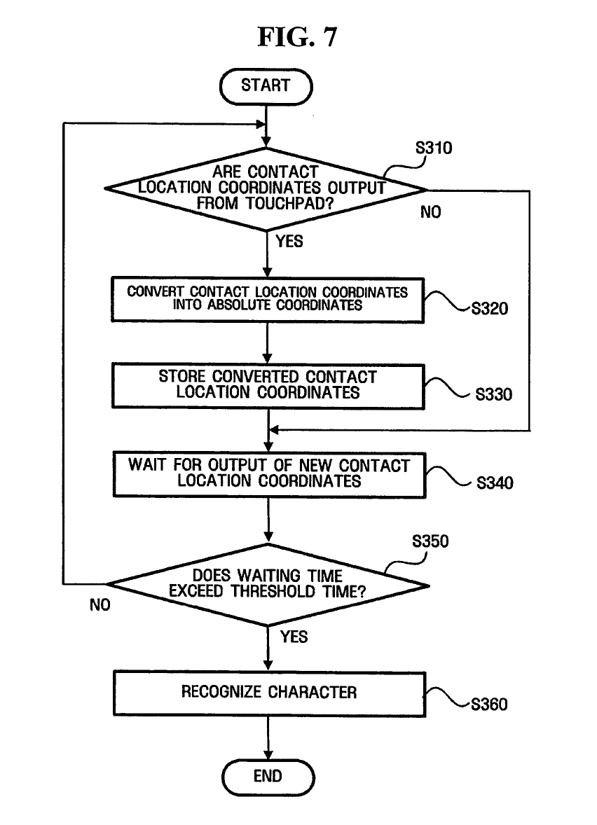

According to an embodiment of the present general inventive concept, the contact location coordinates converted by the coordinate converting unit 234 may be stored, and the stored contact location coordinates may then be recognized as a character, which will now be described with reference to FIGS. 6 and 7.

FIG. 6 is a flowchart illustrating a method of recognizing a character according to an embodiment of the present general inventive concept.

In operation S210, if the contact location coordinates are output from a touchpad unit 210 in the absolute coordinate mode, a coordinate converting unit 234 converts the contact location coordinates into the absolute coordinates in operation S220.

In this case, the storage unit 250 stores the contact location coordinates converted by the coordinate converting unit 234 into the absolute coordinates in operation S230.

If a recognition command is not input by a user in operation S240, operations S210 using S230 are repeatedly performed. In this operation, the storage unit 250 stores contact location coordinates newly converted by the coordinate converting unit 234 as one group, together with contact location coordinates that have been previously stored.

If the recognition command is input by the user in operation S240, the recognizing unit 260 recognizes a character through the contact location coordinates stored in the storage unit 250 as one group in operation S250.

If the new contact location coordinates are converted by the coordinate converting unit 234 after character recognition, the storage unit 250 stores the converted contact location coordinates as a new group. Thus, all the contact location coordinates converted before another character recognizing process is performed are stored in the same group.

FIG. 7 is a flowchart illustrating a method of recognizing a character according to another embodiment of the present general inventive concept.

In operation S310, if the contact location coordinates are output from the touchpad unit 210 in the absolute coordinate mode, the coordinate converting unit 234 converts the contact location coordinates into the absolute coordinates in operation S320.

In this case, the storage unit 250 stores the contact location coordinates converted by the coordinate converting unit 234 into the absolute coordinates in operation S330.

If the contact location coordinates are not output from the touchpad unit 210 in operation S310, the recognizing unit 260 waits for new contact location coordinates to be output from the touchpad unit 210 in operation S340 for a time interval not exceeding a threshold time interval. If the waiting time does not exceed a threshold time interval, operations S310 using S340 are performed repeatedly. If the waiting time does not exceed the threshold time interval, the storage unit 250 stores contact location coordinates newly converted by the coordinate converting unit 234 as one group, together with contact location coordinates that have been previously stored.

If the waiting time exceeds the threshold time interval in operation S350, the recognizing unit 260 recognizes a character using the contact location coordinates stored in the storage unit 250 as one group in operation S360.

If the new contact location coordinates are converted by the coordinate converting unit 234 after character recognition, the storage unit 250 stores the converted contact location coordinates as a new group. Thus, all the contact location coordinates converted before another character recognizing process is performed are stored in the same group.

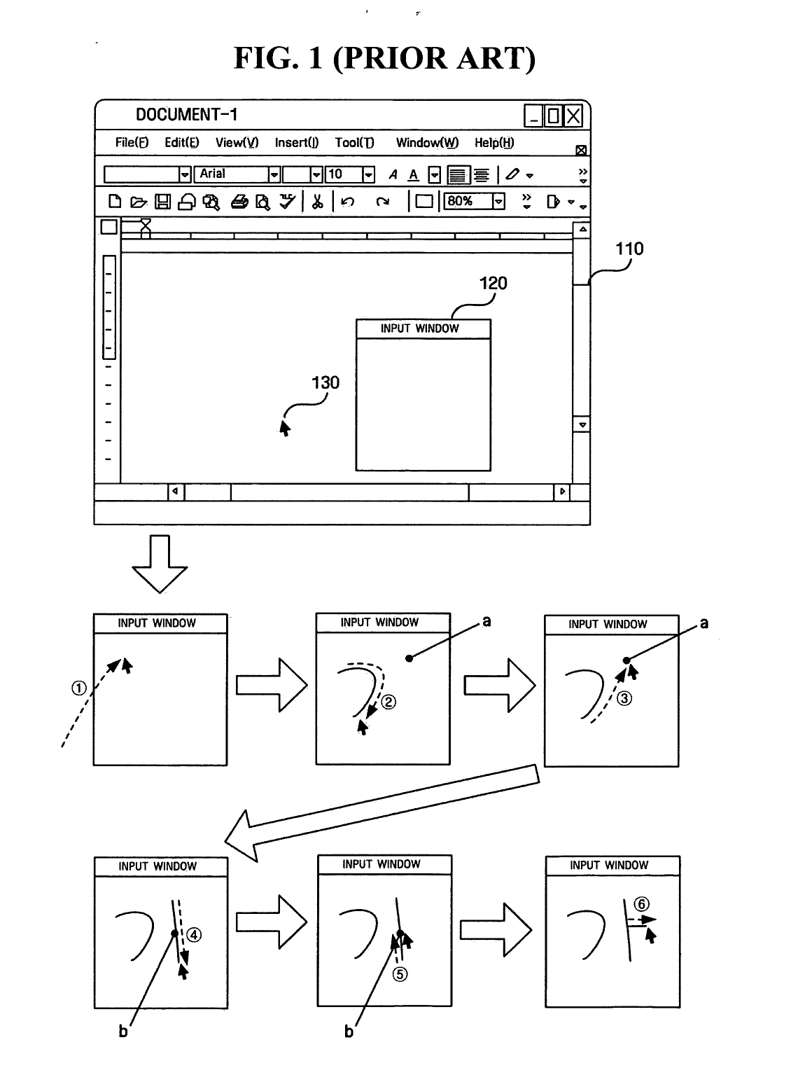

In this way, according to the embodiments of the present general inventive concept, drag operations (3 and 5) of the pointing tool for changing locations of the mouse pointer may be omitted in the character input process illustrated in FIG. 1. Thus, the user can directly input a character using a touchpad in such a manner that he or she can write with a pen or can use a finger.

After character recognition, new contact location coordinates converted by the controlling unit 230 as absolute coordinates are stored in the storage unit 250 as a new group.

While the character recognition process has been described above with reference to FIGS. 6 and 7, numbers or other symbols can also be recognized by the same operation as described previously.

According to another embodiment of the present general inventive concept, a displayed movement path of a mouse pointer may be stored as image data using a group of contact location coordinates stored in a storage unit 250. In this case, the image generating operation using an image generating unit 270 may be performed instead of the character recognition operation S250 illustrated in FIG. 6 and the character recognition operation S360 illustrated in FIG. 7.

As described above, in the apparatus and method of processing touchpad input information according to various embodiments of the present general inventive concept, an input region of a touchpad is mapped to a display region as absolute coordinates, thereby enabling a user to input information directly using the touchpad.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of processing touchpad input information, the method comprising:
mapping an input region of a touchpad to a predetermined display region as absolute coordinates;
converting contact location coordinates into the absolute coordinates when a pointing unit touches the input region; and
moving a mouse pointer displayed on the display region according to the converted contact location coordinates.

2. The method of claim 1, further comprising displaying a movement path of the mouse pointer on the display region corresponding to a sequence of contact location coordinates.

3. The method of claim 2, further comprising:
storing the converted contact location coordinates; and
recognizing a character using the stored contact location coordinates.

4. The method of claim 3, further comprising displaying the recognized character.

5. The method of claim 4, wherein the displayed recognized character replaces the displayed mouse pointer path.

6. The method of claim 3, wherein the recognizing a character is performed when character recognition is requested by a user or when the pointing tool does not touch the touchpad for more than a threshold time interval.

7. The method of claim 2, further comprising storing a movement path of the mouse pointer as image data.

8. A method of processing locations pointed to within a predetermined area, the method comprising:
mapping the input region of the predetermined area to a display region of a display as absolute coordinates;
converting location coordinates in the predetermined area into absolute coordinates when the locations are pointed to; and
moving a pointer along the display region corresponding to the converted location coordinates pointed to.

9. An apparatus to process touchpad input information, the apparatus comprising:
a coordinate setting unit to map location coordinates of an input region of a touchpad to a display region as absolute coordinates;
a coordinate converting unit to convert the location coordinates where a pointing unit touches the touchpad into the corresponding absolute coordinates; and
a mouse pointer controlling unit to move a mouse pointer displayed on the display region according to the converted contact location coordinates.

10. The apparatus of claim 9, wherein the mouse pointer controlling unit displays a movement path of the mouse pointer on the display region.

11. The apparatus of claim 10, further comprising:
a storage unit to store the converted contact location coordinates; and
a recognizing unit to recognize a character using the stored touch location coordinates.

12. The apparatus of claim 11, wherein the character recognition is performed when character recognition is requested by a user or when the pointing tool does not touch the touchpad for more than a threshold time interval.

13. The apparatus of claim 10, further comprising an image generator to store the movement path of the mouse pointer as image data.

14. An apparatus to recognize characters from information input using an input device capable of sensing a touch and outputting touch location coordinates, the apparatus comprising:
a display;
a converting unit to convert touch location coordinates sensed by the input device into absolute display coordinates;
a group processing unit to group a sequence of absolute coordinates and to control displaying the group of coordinates on the display; and
a recognizing unit to recognize a character based on a largest correlation between a group of coordinates and a reference character from a plurality of reference characters.

15. The apparatus of claim 14 further comprising:
a storage unit to store upon request display image or a sequence of recognized characters.

16. The apparatus of claim 14 further comprising:
a switch to allow a user to select between an absolute coordinates mode and a relative coordinates mode wherein in the relative coordinates mode, the relative coordinates are used instead of the absolute coordinates.

17. The apparatus of claim 14, further comprising:
a post-processing document unit to process the recognized characters to form a document with reference characters.

18. An apparatus to process locations pointed to within a predetermined area, the apparatus comprising:
a mapping unit to map the input region of the predetermined area to a display region of a display as absolute coordinates;
a conversion unit to convert location coordinates in the predetermined area into absolute coordinates when the locations are pointed to; and
a display to display the movements of a pointer along the display region corresponding to the converted location coordinates pointed to.
